(19) United States
(12) Patent Application Publication
(10) Pub. No.: US 2005/0249646 A1
(43) Pub. Date: Nov. 10, 2005

(54) Gas treatment apparatus

(75) Inventors: Hideo Iwama, Kamakura-shi (JP); Toshiji Nishiguchi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/116,323

(22) Filed: Apr. 28, 2005

(30) Foreign Application Priority Data
May 7, 2004 (JP) 2004-138409
Mar. 17, 2005 (JP) 2005-077160

(51) Int. Cl. G02F 1/1333; B01J 19/08

(52) U.S. Cl. 422/186.21; 422/186.04

(57) ABSTRACT

The present invention provides a gas treatment apparatus having a plasma reactor. The plasma reactor includes plural linear ground electrodes, plural linear high-voltage electrodes, and an inorganic dielectric layer having a porous structure. The plural linear ground electrodes are disposed on a first plane in parallel to one another. The plural linear high-voltage electrodes are disposed in parallel to one another on a second plane that is parallel with the first plane. The porous inorganic dielectric layer having the porous structure is provided between the plural linear high-voltage electrodes and the plural linear ground electrodes. At least one of a set of the plural linear ground electrodes and a set of the plural linear high-voltage electrodes is entirely covered with an inorganic dielectric.

### BACKGROUND OF THE INVENTION

1. Field of the Invention

The present invention relates to an apparatus for treating a gas, which contains odorants, biological materials, such as viruses or bacteria, and pollen, with plasma generated by discharging electricity under atmospheric pressure.

2. Description of the Related Art

Japanese Patent Laid-Open No. 2002-50500 discloses utilizing plasma generated by placing an inorganic dielectric between electrodes and by applying an alternating voltage or a pulse voltage therebetween as a technique of treating an atmospheric gas.

Further, Japanese Patent Laid-Open No. 2002-345938 discloses a deodorizing apparatus having a photocatalytic module (corresponding to a discharging means) configured so that each photocatalytic filter, which is constituted by a photocatalyst, such as titanium oxide, sintered onto the surface of a porous ceramic substrate, is sandwiched between paired mesh-like electrodes.

Japanese Patent Laid-Open No. 2002-50500 discloses an effective technique for treating a gas with plasma generated by filling a space between the electrodes with the inorganic dielectric and by applying an alternating voltage or a pulse voltage therebetween.

Although a structure in which the space between electrodes is filled with an inorganic dielectric is a favorable countermeasure against a pressure loss, there is still room for improvement in a case where pressure loss is reduced and a plasma reactor is miniaturized without reducing the efficiency in treating a gas present in the atmosphere.

To reduce the pressure loss and miniaturize the plasma reactor, there is a need to increase the porosity of the inorganic dielectric located between the electrodes and to decrease as much as possible the distance between the high-voltage electrode and the ground electrode. Thus, it has been considered that plasma is generated by sandwiching a thin and highly porous inorganic dielectric between the electrodes and applying a voltage therebetween.

The discharging means of the deodorizing apparatus described in Japanese Patent Laid-Open No. 2002-50500 is configured so that each of the porous photocatalysts is sandwiched between the paired mesh electrodes. However, with this configuration, it is difficult to treat a gas by utilizing plasma, if one is to proceed as described in Japanese Patent Laid-Open No. 2002-50500. This apparatus provides advantages in connection with the gas treatment only due to a photocatalytic reaction caused by using plasma emission light as a light source. When the porosity of the thin and porous inorganic dielectric is increased, it is possible that a spark discharge will occur, in a part in which the inorganic dielectric is not present between the high-voltage electrode and the ground electrode. Thus, an optimal voltage cannot be applied to prevent the occurrence of this spark discharge. Originally, the apparatus described in Japanese Patent Laid-Open No. 2002-345938 deodorizes the air by utilizing a photocatalytic reaction, which is caused by using plasma emission light as a light source, and by using ozone generated by producing plasma.

Accordingly, no methods have been proposed for reducing the pressure loss, which is caused during a high speed treatment of a gas in the atmosphere, and for miniaturizing plasma reactors in inorganic dielectric filling type plasma technology in which a pulse-like micro-discharge is generated due to polarization in the inorganic dielectric placed between the electrodes, which micro-discharge is caused by applying a high alternating voltage or a pulse-voltage between the opposed electrodes to thereby provide a difference in potential therebetween, and in which a gas is treated by using this micro-discharge.

### SUMMARY OF THE INVENTION

According to the present invention, there is provided a plasma gas treatment apparatus that includes a gas inlet, a gas exhaust, and a plasma reactor. The plasma reactor includes plural linear ground electrodes, plural linear high-voltage electrodes, and an inorganic dielectric layer having a porous structure. The plural linear ground electrodes are disposed on a first plane in parallel to one another. The plural linear high-voltage electrodes are disposed in parallel to one another on a second plane that is parallel to the first face. The inorganic dielectric layer having the porous structure is provided between the plural linear high-voltage electrodes and the plural linear ground electrodes. At least one of a set of the plural linear ground electrodes and a set of the plural linear high-voltage electrodes is entirely covered with an inorganic dielectric.

Further, according to an embodiment of the plasma gas treatment apparatus of the invention, the plural linear ground electrodes are disposed such that they are “orthogonal” to the plural linear high-voltage electrodes.

Furthermore, according to another embodiment of the plasma gas treatment apparatus of the invention, the inorganic dielectric, with which at least one of the set of the plural linear ground electrodes and the set of the plural high-voltage electrodes is coated, is an insulating material.

Additionally, according to another embodiment of the plasma gas treatment apparatus of the invention, the plural linear ground electrodes, the plural linear high-voltage electrodes, and the inorganic dielectric layer having the porous structure constitute a cartridge that is freely taken out of and put into the plasma gas treatment apparatus.

In the present specification, an “angle formed between the plural linear ground electrodes, which are disposed in parallel to one another on a first plane, and the plural linear high-voltage electrodes, which are disposed in parallel to one another on a second plane” is defined to be an “angle (which ranges from 0 to 90 degrees) formed between the projection of a given one of the plural linear ground electrodes, which are perpendicularly projected onto a third plane that is parallel to both the first plane and the second plane, and the projection of a given one of the plural linear high-voltage electrodes perpendicularly projected onto the third plane”. In a case where the “angle formed between the plural linear ground electrodes and the plural linear high-voltage electrodes” is 90 degrees, the plural linear ground electrodes are described as being “orthogonal” to the plural linear high-voltage electrodes.

Other features and advantages of the invention will become apparent to those skilled in the art upon reading the following detailed description in conjunction with the accompanying drawings, in which like reference characters designate the same or similar parts throughout the figures.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic general view showing a first configuration of a plasma reactor according to an embodiment of the invention.

FIG. 2 is a schematic general view showing a second configuration of the plasma reactor according to this embodiment.

FIG. 3 is a schematic general view showing a third configuration of the plasma reactor according to this embodiment.

FIG. 4 is a schematic general view showing a fourth configuration of the plasma reactor according to this embodiment.

FIG. 5 is a table showing results of a gas treatment performed by using the plasma reactors of the configurations of this embodiment respectively shown in FIGS. 1 to 4.

FIG. 6 is a schematic general view showing the configuration of a gas treatment apparatus according to this embodiment.

### DETAILED DESCRIPTION OF THE EMBODIMENTS

Embodiments of the invention will be described in detail below with reference to the drawings.

In an embodiment of the invention, a plasma gas-treatment apparatus has a plasma reactor. The plasma reactor has plural linear ground electrodes, plural linear high-voltage electrodes, and an inorganic dielectric layer that has a porous structure. The plural linear ground electrodes are disposed in parallel to one another on a first plane. The plural linear high-voltage electrodes are disposed in parallel to one another on a second plane that is parallel to the first plane. The inorganic dielectric layer having the porous structure is provided between the plural linear ground electrodes and the plural linear high-voltage electrodes. At least one of a set of the plural linear ground electrodes and a set of the plural linear high-voltage electrodes is entirely covered with another inorganic dielectric.

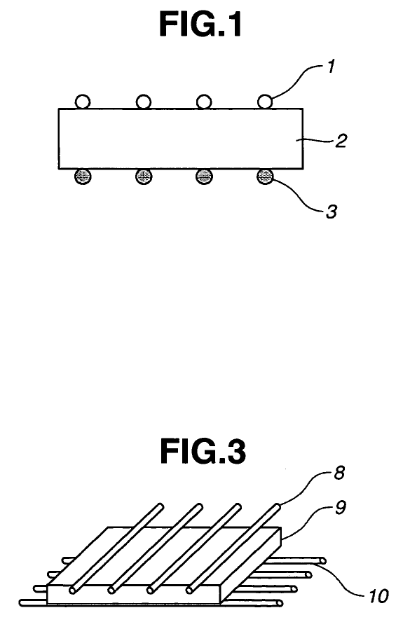

The plasma gas-treatment apparatus according to the present invention may be configured as shown in any one of FIGS. 1, 2, 3, and 4. This apparatus forcibly intakes an odorous gas, which is produced, for example, by mixing 5 ppm of an ammonia gas into the air, through a gas inlet at a rate of, for example, 1 m³/minute by using an intake fan placed at the subsequent stage of the plasma reactor. FIG. 5 shows the voltage applied to the high-voltage electrode and the treatment efficiency obtained when a one-pass treatment is performed on the odorous gas at the same concentration of the odorous gas under the same gas-treatment space movement conditions in the case of employing each of the configurations shown in FIGS. 1 to 4, respectively. The constituent components of the plasma reactor shown in each of FIGS. 1 to 4 are only the electrodes and the inorganic dielectric having a porous structure. Parts respectively provided around the electrodes and the porous inorganic dielectric are shaped so that the gas does not leak therefrom. The gas flows only through the porous structure of the inorganic dielectric.

The plasma reactor shown in FIG. 1 has plural linear ground electrodes 1, a porous inorganic dielectric 2, and plural linear high-voltage electrodes 3. The plural linear ground electrodes 1 are disposed in parallel to one another on the first plane and are made of a stainless material. The porous inorganic dielectric 2 is provided between the plural linear high-voltage electrodes 1 and the plural linear ground electrodes 2. The dielectric is made of a mixture of barium titanate and alumina. The plural linear high-voltage electrodes 3 are disposed in parallel to one another on the second plane, which is parallel to the first plane, and are made of a tungsten material. The plural linear ground electrodes 1 and the plural linear high-voltage electrodes 3 are disposed so that each of the plural linear ground electrodes 1 is opposed and parallel to an associated one of the plural linear high-voltage electrodes 3. The apparatus may have a structure in which plural stages of the plural linear ground electrodes and plural stages of the plural high-voltage electrodes are alternately provided.

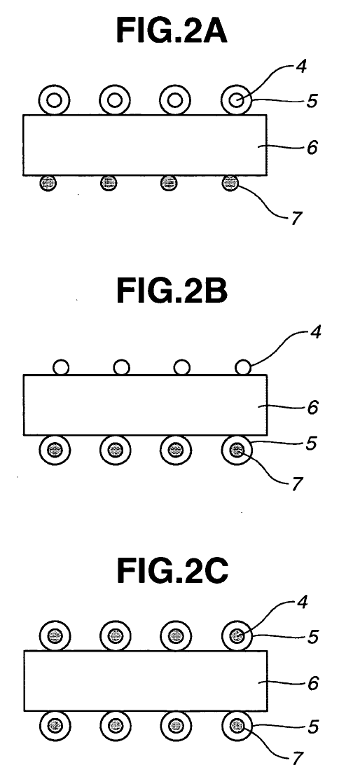

The plasma reactor shown in FIG. 2A has plural linear ground electrodes 4, coatings 5 thereof, a porous inorganic dielectric 6, and the plural linear high-voltage electrodes 7. The plural linear ground electrodes 4 are disposed in parallel to one another on the first plane and are made of a stainless material. Each of the coatings 5, which is constituted by an inorganic dielectric, covers the entire surface of a corresponding ground electrode 4. In this embodiment, alumina tubes are used as the coatings 5. Each of the tubes is fitted onto a ground electrode so that the inside diameter of each of the tubes matches the outside diameter of the corresponding ground electrode. The porous inorganic dielectric 6 is provided between the plural linear ground electrodes 4 and the plural linear high-voltage electrodes 7, and is made of a mixture of barium titanate and alumina. The plural linear high-voltage electrodes 7 are disposed in parallel to one another on the second plane, which is parallel to the first plane, and is made of a tungsten material. The plural linear ground electrodes 4 and the plural linear high-voltage electrodes 7 are disposed so that each of the plural linear ground electrodes 4 is opposed and parallel to an associated one of the plural linear high-voltage electrodes 7. FIG. 2B shows a modification in which the entire surface of each of the plural linear high-voltage electrodes 7 is covered with the coating 5 constituted by an inorganic dielectric. FIG. 2C shows another modification in which the entire surface of each of the plural linear ground electrodes 4 and the plural linear high-voltage electrodes 7 is covered with the coating 5 constituted by an inorganic dielectric. With such configurations, spark discharges can efficiently be prevented. Also, the supply of stable plasma discharges can be achieved.

The the plasma reactor shown in FIG. 3 has plural linear ground electrodes 8, a porous inorganic dielectric 9, and plural linear high-voltage electrodes 10. The plural linear ground electrodes 8 are disposed in parallel to one another on the first plane and are made of a stainless material. The porous inorganic dielectric 9 is provided between the plural linear high-voltage electrodes 10 and the plural linear ground electrodes 8, and is made of a mixture of barium titanate and alumina. The plural linear high-voltage electrodes 10 are disposed in parallel to one another on the second plane, which is parallel to the first plane, and are made of a tungsten material. The plural linear ground electrodes 8 and the plural linear high-voltage electrodes 10 are disposed so that each of the plural linear ground electrodes 8 is opposed to an associated one of the plural linear high-voltage electrodes 10 and is “orthogonal” to the plural linear high-voltage electrodes 10.

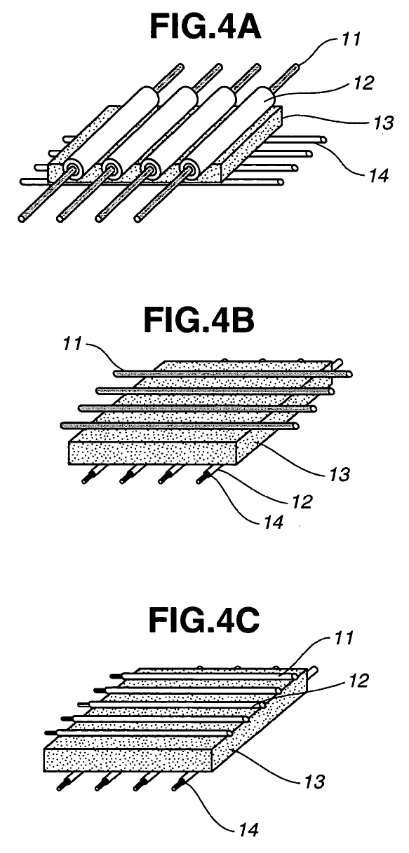

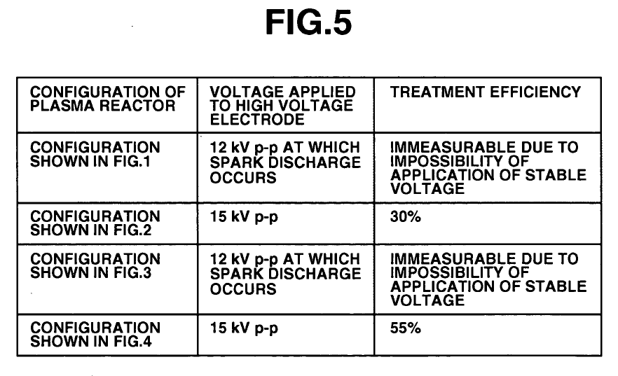

The plasma reactor shown in FIG. 4A has plural linear ground electrodes 11, coatings 12 thereof, a porous inorganic dielectric 13, and plural linear high-voltage electrodes 14. The plural linear ground electrodes 11 are disposed in parallel to one another on the first plane and are made of a stainless material. Each of the coatings 12 comprises an inorganic dielectric, covering the entire surface of a corresponding electrode. In this embodiment, alumina tubes are used as the coatings 12. Each of the tubes is fitted onto the corresponding electrode so that the inside diameter of each of the tubes matches the outside diameter of the corresponding electrode. The porous inorganic dielectric 13 is provided between the plural linear high-voltage electrodes 14 and the plural linear ground electrodes 11, and is made of a mixture of barium titanate and alumina. The plural linear high-voltage electrodes 14 are disposed in parallel to one another on the second plane, which is parallel to the first plane, and are made of a tungsten material. The plural linear ground electrodes 11 and the plural linear high-voltage electrodes 14 are disposed so that each of the plural linear ground electrodes 11 is opposed to an associated one of the plural linear high-voltage electrodes 14 and is “orthogonal” to the plural linear high-voltage electrodes 14. FIG. 4B shows a modification in which the entire surface of each of the plural linear high-voltage electrodes 14 is covered with the coating 12 constituted by an inorganic dielectric. FIG. 4C shows another modification in which the entire surface of each of the plural linear ground electrodes 11 and the plural linear high-voltage electrodes 14 is covered with the coating 12 constituted by an inorganic dielectric. With such configurations, spark discharges can efficiently be prevented. Also, the supply of stable plasma discharges can be achieved.

As can be seen in a table shown in FIG. 5, which presents the results of performing the one-pass treatment on the ammonia-containing odorous gas in the plasma reactors having the configurations respectively shown in FIGS. 1 to 4, the best result of the treatment, that is, a treatment efficiency of 55% was obtained in the case of employing the configuration shown in FIG. 4. Further, it is also found that even in the case of employing the configuration shown in FIG. 2, a treatment efficiency of 30% was obtained as the result of the treatment. Thus, the plasma reactor of the configuration shown in FIG. 2 may be used in a circulating type gas treatment apparatus. The plasma reactor of the configuration shown in FIG. 4 is more preferable.

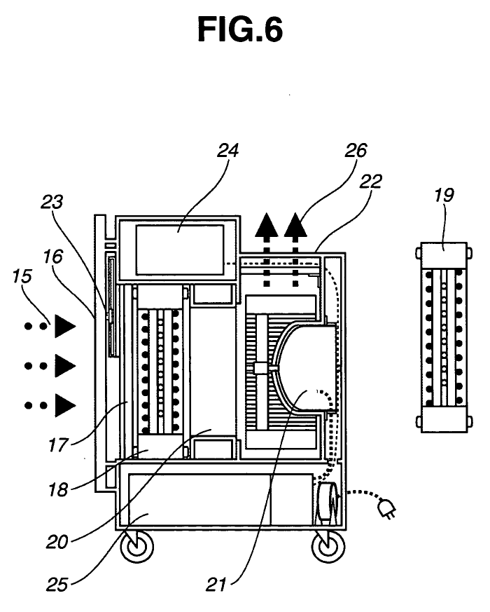

FIG. 6 is a schematic view showing the configuration of a gas treatment apparatus according to this embodiment of the present invention. The gas treatment apparatus has a gas inlet 16 for introducing a gas containing a treatment object material 15, a prefilter 17, a fixed type plasma reactor 18, a catalyst 20, an inlet-exhaust fan motor 21, a gas exhaust 22 for exhausting a gas from which a treated material is removed 26, a gas-treatment-object detecting sensor 23, an operation panel/operation board and the like 24, and a high-voltage generating device 25 for discharging. The fixed type plasma reactor 18 in this apparatus can be replaced with a cartridge type plasma reactor 19. Each of the fixed type plasma reactor 18 and the cartridge type plasma reactor 19 corresponds to the plasma reactor according to this embodiment.

The gas treatment apparatus having the fixed type plasma reactor 18 or the cartridge type plasma reactor 19 according to this embodiment can treat a gas, which contains an odorant, a biological material, such as a virus or a bacterium, and pollen, with plasma, which is generated by discharging electricity at atmospheric pressure, by letting the gas pass therethrough.

The gas treatment apparatus according to the present invention can eliminate, for example, the smell of tobacco smoke and body odors generated in living spaces, meeting rooms, hotels, offices, or any space where people gather, and odors generated at garbage disposal areas. Also, the gas treatment apparatus according to the present invention can eliminate viruses, bacteria, and pollen, and the like, which are present in the air in hospitals and domestic living spaces.

According to the embodiments, the pressure loss can be reduced without decreasing the efficiency in treating a gas in the atmosphere. Also, spark discharges can be prevented and the supply of stable plasma discharges can be achieved. Additionally, the miniaturization of plasma reactors can be achieved.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-138409, filed May 7, 2004, which is hereby incorporated by reference.

1. A plasma gas treatment apparatus comprising:
a gas inlet;
a gas exhaust; and
a plasma reactor,
wherein the plasma reactor includes plural linear ground electrodes, plural linear high-voltage electrodes, and a porous dielectric,
wherein the plural linear ground electrodes are disposed on a first plane in parallel to one another,
wherein the plural linear high-voltage electrodes are disposed in parallel to one another on a second plane that is parallel to the first plane,
wherein the porous inorganic dielectric is provided between the plural linear high-voltage electrodes and the plural linear ground electrodes, and
wherein at least one of a set of the plural linear ground electrodes and a set of the plural linear high-voltage electrodes is entirely covered with an inorganic dielectric material.

2. The plasma gas treatment apparatus according to claim 1, wherein each one of the plural linear ground electrodes is orthogonal to the plural linear high-voltage electrodes.

3. The plasma gas treatment apparatus according to claim 1, wherein the inorganic dielectric material, with which said at least one of the set of the plural linear ground electrodes and the set of the plural high-voltage electrodes is coated, is an insulating material.

4. The plasma gas treatment apparatus according to claim 1, wherein the plural linear ground electrodes, the plural linear high-voltage electrodes, and the porous inorganic dielectric constitute a cartridge that is capable of being taken out of and put into the plasma gas treatment apparatus.
